(19) United States
(12) Patent Application Publication
(10) Pub. No.: US 2026/0368497 A1
(43) Pub. Date: Nov. 19, 2026

(54) AUTOMATED TIME SERIES SYNTHESIS THROUGH INTELLIGENT MODEL SELECTION

(71) Applicant: Remix Labs LLC, Old Greenwich, CT (US)

(72) Inventors: Thiam Hui Lee, New York, NY (US); Amir Husain, Austin, TX (US)

(73) Assignee: Remix Labs LLC, Old Greenwich, CT (US)

(21) Appl. No.: 19/209,420

(22) Filed: May 15, 2025

(51) Int. Cl. G06N 3/0475; G06N 3/0442

(52) U.S. Cl. CPC G06N 3/0475; G06N 3/0442

(57) ABSTRACT

A system for time series data synthesis provides automated analysis and model selection capabilities through an integrated modular architecture. The system includes a data management module enabling users to upload time-series data and navigate both source and synthesized data through an intuitive interface. A data synthesis module analyzes source data characteristics to recommend appropriate synthesis models, allows users to select specific variables and models, and enables modification of default parameters based on automated data analysis. The system processes synthesis tasks asynchronously through a task execution module while maintaining comprehensive task tracking. Through its synthesis capabilities, the system performs interpolation to fill data gaps, extrapolation for temporal extension, and data augmentation while preserving source data characteristics. The system's ability to transform unstructured time-sequential data into structured time-series formats provides practical utility for data processing and analysis applications.

### BACKGROUND OF THE INVENTION

### 1. Field of Invention

The invention pertains to artificial intelligence, specifically in generating synthetic time series data to improve machine learning and predictive analytics.

### 2. Description of Related Art

Computer systems implementing artificial intelligence (AI) models face significant technical challenges in processing and learning from time series data. These systems require extensive computational resources and specialized infrastructure to analyze temporal patterns for predictive modeling effectively. The technical limitations in acquiring and processing real-time series data create substantial barriers for computer systems, particularly in data-intensive domains such as but not limited to financial modeling and healthcare analytics, where real-time series data is limited or difficult to obtain. The computational overhead of collecting and processing real-world data strains system resources and requires complex infrastructure configurations. Additionally, computer systems must implement sophisticated security protocols to handle sensitive data, creating additional technical complexity. Robust time series data is essential for AI models to learn patterns over time, enabling them to make accurate predictions about future events.

Modern computing systems encounter numerous technical obstacles in processing time series data. System interruptions and hardware failures result in fragmented datasets that compromise computational accuracy. The technical challenge of processing data at varying frequencies, from milliseconds to daily intervals, creates significant computational complexity when integrating multiple data streams. Missing values can significantly affect the accuracy of AI models trained on this data. Computer systems must implement specialized algorithms to handle missing values, noise filtering, and outlier detection, all of which require substantial processing power. The technical demands are particularly acute in Internet-of-Things (IoT) architectures, where systems must process multi-dimensional metrics in real time while managing high-volume data ingestion, storage optimization, and query performance.

Synthesized time series data addresses these challenges and is a powerful AI and machine learning resource. Synthesized data can fill gaps, providing sufficient training material for machine learning models when real data is scarce or hard to collect. Synthesizing data can also significantly reduce costs and the time required to gather adequate datasets, allowing for quicker model development and iteration. Synthetic data also will enable organizations to simulate realistic datasets without compromising individual privacy, making it a valuable tool for testing and training without ethical concerns. Synthetic time series data can represent various scenarios, including rare events that may not be well-represented in real datasets. This variety helps improve the robustness of predictive models by allowing them to learn from a broader spectrum of potential outcomes. Moreover, synthetic time series data can provide a controlled environment for testing algorithms and validating models under various scenarios without the risks associated with using live data in fields like autonomous driving or financial forecasting, where testing on real-world data could lead to negative consequences. This richness enhances the AI's ability to analyze complex interactions within the data, leading to more intelligent insights.

Existing computer-implemented approaches for synthesizing time-series data have significant technical limitations. While Generative Adversarial Networks (GANs) provide one technical solution, they suffer from computational instability and inconsistent output quality due to architectural constraints and parameter sensitivity. The processing requirements and system resource utilization vary unpredictably during training. Variational autoencoders (VAEs) offer an alternative technical implementation but face computational challenges in high-dimensional spaces. These systems struggle to maintain consistent output quality while managing computational resources effectively. Statistical approaches provide basic computational functionality but fail to capture the complex technical relationships present in the data. These implementations oversimplify the underlying computational models, resulting in reduced system accuracy.

These technical limitations create a critical need for an improved computer-implemented methodology that can (1) optimize system performance in capturing temporal dynamics, (2) implement more efficient frameworks for cross-domain data processing, (3) enhance computational security during model training, and (4) establish improved technical metrics for synthetic data validation. The present invention provides a technical solution through an innovative computer-implemented approach that resolves these fundamental computing challenges.

### SUMMARY OF THE INVENTION

The present invention overcomes these and other deficiencies of the prior art by providing a technical solution through computer-implemented synthetic data generation. This approach resolves fundamental computing challenges by implementing novel algorithms that optimize system resources and enhance processing efficiency. The technical innovation enables computer systems to generate training data without the computational overhead of collecting and processing real data. The system implements specialized data structures and algorithms that facilitate efficient simulation of complex scenarios while maintaining data integrity and system performance. This technical advancement allows computer systems to validate algorithms and test models without the computational risks of processing live data.

The invention is a computer-implemented system and method for synthesizing time series data and other ordered data through automated analysis and model selection. The system analyzes source data characteristics to recommend appropriate synthesis models from a suite of options, including Long Short-Term Memory (LSTM) models for complex temporal patterns, Gated Recurrent Unit (GRU) models for precise sequential control, linear interpolation for approximately linear relationships, and Neural Basis Expansion Analysis Time Series (N-BEATS) models for high-volume datasets. Through a modular architecture comprising data management, synthesis, task execution, and notification components, the system validates and transforms source data, populates optimized default parameters, and executes synthesis operations asynchronously while maintaining task tracking. The system supports multiple synthesis approaches, including interpolation for filling data gaps, extrapolation for temporal extension, and data augmentation while preserving source data characteristics. The invention provides an efficient framework for generating high-quality synthetic data while maintaining user control through configurable parameters and comprehensive task management capabilities.

In an embodiment of the invention, a computer-implemented method for time series data synthesis comprises the steps of receiving, at a computer, time series source data, analyzing, at the computer, the time series source data to identify a recommended synthesis model from a plurality of synthesis models, receiving, at the computer, an identification of a synthesis model from the plurality of synthesis models, populating, at the computer, one or more default parameters of the identified synthesis model based on the step of analyzing the time series source data, and generating, at the computer, synthetic time series data according to the identified synthesis model. The method may further comprise receiving a modification of the one or more default parameters to form one or more modified parameters of the identified synthesis model, wherein the step of generating synthetic time series data according to the identified synthesis model utilizes the one or more modified parameters. The identified synthesis model may be the recommended synthesis model. The step of generating synthetic time series data according to the identified synthesis model comprises one or more steps selected from the group consisting of: interpolating the time series source data, extrapolating the time series source data, augmenting the time series source data, and any combination thereof. Analyzing the time series source data may comprise a step selected from the group consisting of: evaluating data volume and a complexity metric, identifying a temporal pattern, analyzing a data frequency variation, detecting a missing value, assessing a multi-dimensional relationship, and a combination thereof. The plurality of synthesis models may comprise an LSTM model, a GRU model, a linear interpolation mode, and an N-BEATS model. The one or more default parameters may be selected from the group consisting of: a correlation strength, a signal fluctuation, a smoothing coefficient, a temporal delay setting, a random seed value, and a combination thereof. The method may further comprise the steps of storing generated synthetic data with an associated timestamp and providing a notification indicating a completion of the step of generating synthetic time series data. The method may execute synthesis tasks asynchronously while maintaining task progress tracking.

In another embodiment of the invention, a method for synthesizing data according to a primary ordering variable comprises the steps of receiving, at a computer, source data, analyzing, at the computer, the source data to identify a primary ordering variable and a recommended synthesis model from a plurality of synthesis models for the identified primary ordering variable, receiving, at the computer, an identification of a synthesis model from the plurality of synthesis models, populating, at the computer, one or more default parameters of the identified synthesis model based on the step of analyzing the source data, and generating, at the computer, synthetic data according to the identified primary ordering variable and the identified synthesis model. The primary ordering variable may be time or selected from the group consisting of: a spatial coordinate, a sequential identifier, a distance, an energy level, a hierarchical level, a process stage, age, growth stage, temperature, pressure, and any combination thereof.

In yet another embodiment of the invention, a system for time series data synthesis comprises a data management module configured to receive time series source data and validate and transform the time series source data into a standardized format optimized for synthesis operations; a data synthesis module configured to analyze characteristics of the time series source data and recommended a synthesis model from a plurality of synthesis models based on the analyzed characteristics, populate default synthesis parameters based on the analyzed characteristics, and process the time series source data according to the recommended synthesis model; and a task execution module configured to manage synthesis operations asynchronously, coordinate data flow between modules, track task progress and completion status, and implement task recovery for interrupted operations. The system may further comprise a notification module configured to alert that data synthesis is complete. The plurality of synthesis models comprises an LSTM model, a GRU model, a linear interpolation model, and an N-BEATS model. The data synthesis module may be configured to perform interpolation to fill data gaps, extrapolation for temporal extension, or data augmentation.

In another embodiment of the invention, a non-transitory computer-readable storage medium storing instructions that, when executed by a processor, cause the processor to perform operations comprising receiving time series source data, analyzing the time series source data to characteristics, automatically selecting a recommended synthesis model from a plurality of synthesis models based on the analyzed characteristics; populating default synthesis parameters based on the analyzed characteristics; and generating synthetic time series data according to the recommended synthesis model. The plurality of synthesis models comprises an LSTM model configured to process datasets with complex temporal patterns and long-term dependencies, a GRU model configured to process sequential data requiring precise control, a linear interpolation model configured to process datasets with approximately linear relationships, and an N-BEATS model configured to process high-volume temporal datasets. The step of generating synthetic time series data may comprise a step selected from the group consisting of: performing interpolation, performing extrapolation, performing data augmentation, and tracking synthesis task completion. The default synthesis parameters may be selected from the group consisting of: a correlation strength, a signal fluctuation, a smoothing coefficient, a temporal delay setting, a random seed value, and a combination thereof.

The present invention provides several advantages. It offers a user-friendly interface for data management and navigation, enabling users to handle large volumes of time-series data efficiently. The system's ability to perform interpolation, extrapolation, and data augmentation allows users to enhance the quality and quantity of their data. Moreover, the system's asynchronous task execution enables users to perform other tasks during the execution of the data synthesis task, thereby improving productivity.

The preceding paragraphs have been provided as a general introduction and are not intended to limit the scope of the following claims. The described embodiments and further advantages will be best understood by reference to the following detailed description in conjunction with the accompanying drawings.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a system architecture according to an embodiment of the invention and

FIG. 2 illustrates a method for synthesizing time series data through a structured workflow according to an embodiment of the invention.

### DETAILED DESCRIPTION OF PREFERRED EMBODIMENTS

Aspects of the present invention are best understood by reference to the detailed description set forth herein. However, it should be understood that the following description, while indicating preferred embodiments and numerous specific details, is given by illustration only and should not be considered limiting. Changes and modifications may be made without departing from the spirit and scope thereof, and the present invention herein includes all such modifications.

While the present invention is described in the context of using time as the primary ordering variable, one or more alternative primary ordering variables may be implemented, such as but not limited to spatial coordinates (including geographic coordinates, Cartesian coordinates, polar coordinates, and relative positioning data), sequential identifiers (including numeric sequences, alphanumeric sequences, categorical orderings, and indexed series), dimensional measurements (including distances, depths, heights, volumes, and surface areas used across scientific and engineering fields), energy-related variables (including energy levels, wavelengths, frequencies, amplitudes, and phase transitions observed in physics, chemistry, and materials science), hierarchical structures (including organizational taxonomies, biological classifications, network topologies, and nested relationships), process-based progressions (including manufacturing stages, chemical reactions, biological processes, and system states), developmental indicators (including age, growth stages, maturity levels, and lifecycle phases used in biology, medicine, and developmental studies), environmental conditions (including temperature, pressure, humidity, density, viscosity, and other physical properties), and any combinations or derivatives thereof, in place of or in addition to time. The system can process these ordering variables independently or in multi-dimensional combinations to enable synthesis across diverse application domains.

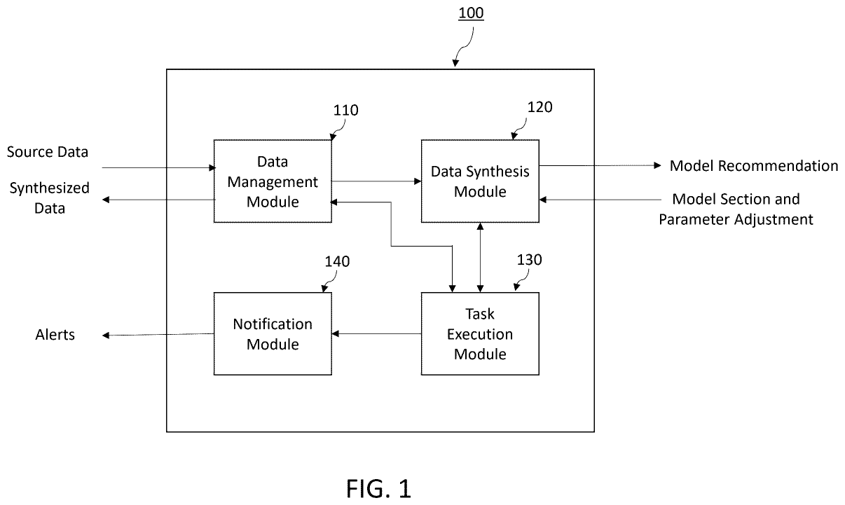

Referring now to FIG. 1, a system architecture diagram illustrates the components and data flows of system 100 for time series data synthesis, according to an embodiment of the invention. System 100 implements a modular architecture optimized for temporal data processing through four modules: a data management module 110, a data synthesis module 120, a task execution module 130, and a notification module 140. These modules operate through coordinated data flows to enable efficient processing and generation of synthetic time-series data while maintaining comprehensive task tracking and user notification capabilities. The system architecture supports horizontal scaling through container orchestration and implements security through role-based access control and end-to-end encryption of sensitive data. Through this integrated approach, system 100 provides an adaptable framework for generating high-quality synthetic data while maintaining user control over critical processing decisions.

The data management module 110 implements a hierarchical data storage architecture that automatically validates and transforms incoming time-series data into a standardized format optimized for synthesis operations. Module 110 employs a virtual file system interface presenting both local and distributed storage resources through a unified API for seamless data asset navigation while implementing automatic versioning and maintaining metadata indices for efficient querying.

The data synthesis module 120 provides a computational pipeline for data processing and model execution. Module 120 implements automated feature extraction to identify temporal patterns and dependencies within source data. For model selection, module 120 employs an automated analysis pipeline evaluating data characteristics, including seasonality, trend components, and noise levels, to recommend optimal synthesis approaches. The interpolation engine uses cubic spline algorithms for gap-filling, while extrapolation leverages statistical and neural approaches based on data characteristics. Module 120 implements automatic parameter tuning through Bayesian optimization.

The task execution module 130 implements a distributed task scheduler managing synthesis operations across available computing resources. Tasks are automatically partitioned and distributed based on data volume and computational requirements. Module 130 implements automatic failover and task recovery mechanisms, maintaining progress tracking through a distributed state store that enables task resumption after interruptions.

The notification module 140 implements a publish-subscribe architecture managing user alerts through multiple channels. Module 140 maintains a configurable notification policy engine controlling alert frequency and aggregation. Browser notifications are implemented through WebSocket connections, while email notifications utilize SMTP with automatic retry logic. Module 140 implements exponential backoff for notification attempts.

The modules within system 100 operate through coordinated data flow. Module 110 is the initial entry point, receiving and storing uploaded time-series data in standardized formats accessible to other components. Module 110 interfaces directly with module 120 by providing validated source data for processing. Module 120, upon receiving source data, conducts automated analysis to guide model selection and parameter configuration, then processes the data according to user-selected synthesis approaches. Module 130 receives configured synthesis tasks from module 120 and manages their asynchronous processing, coordinating with module 110 to store generated outputs. Throughout task execution, module 140 maintains communication with both modules 130 and 110 to track completion status and deliver configurable alerts through browser or email channels. Module 110 provides access to source and synthesized datasets through a unified interface.

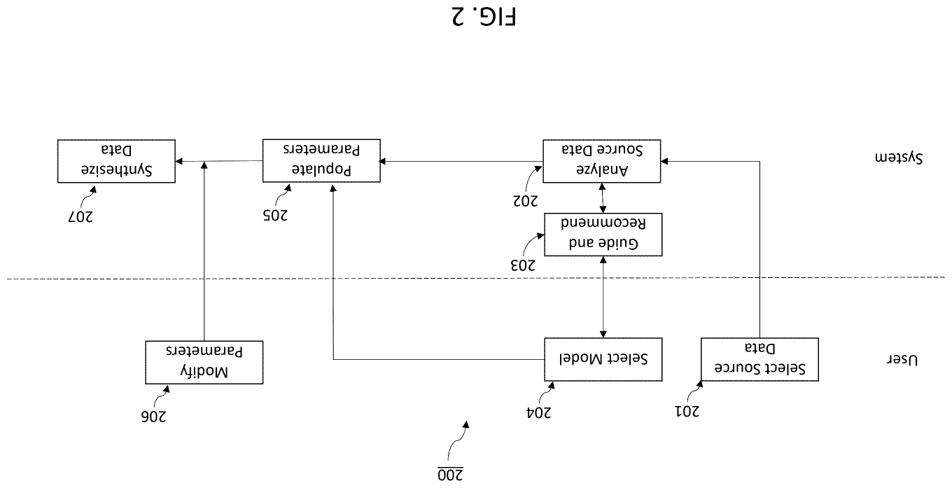

The present invention provides a comprehensive method for synthesizing time series data through a structured workflow, as illustrated in FIG. 2. The workflow diagram depicts operational components and their interactions within the system, showing both user-initiated actions and system processes. Users can systematically select and analyze source data through this integrated approach, choose appropriate synthesis models with system guidance, configure parameters, and generate synthetic data outputs. Method 200 implements multiple interconnected steps that enable efficient processing and generation of synthetic time-series data while maintaining user control over critical decision points throughout the synthesis process.

The method begins with user selection of source time-series data at step 201, where users can select specific variables or columns from the data to determine the sequence and identify columns for interpolation, extrapolation, or data generation. Following data selection, the method analyzes the source data at step 202, where the system provides guidance and recommendations 103 based on the automated analysis.

The system offers multiple sophisticated synthesis models for temporal data processing. In an embodiment of the invention, the system implements a long short-term memory (LSTM) model, a gated recurrent unit (GRU) model, a linear model, a neural basis expansion analysis time series (N-BEATS) model, or combinations thereof. The LSTM model utilizes advanced, recurrent neural network architecture to process extended temporal sequences. Each LSTM unit maintains an internal cell state vector describing retained information from previous units, making it ideal for processing large datasets with complex temporal characteristics. The Gated Recurrent Unit (GRU) model employs specialized neural network architecture with dual-gate control mechanisms. The reset gate evaluates historical state retention, while the update gate manages new data integration, enabling precise temporal information processing. The system implements linear interpolation for datasets with approximately linear relationships using polynomial functions to determine intermediate values. While effective for closely spaced data points, this approach has limitations when processing non-linear patterns or extrapolating beyond known data ranges. The N-BEATS model uses block-based neural network architecture for temporal predictions. Its iterative prediction refinement process through computational blocks enables efficient processing of high-volume temporal datasets compared to traditional recurrent neural networks. The system also allows an appropriate model for forward and backward extrapolation tasks, interpolation for handling missing values, and data augmentation.

The system recommends the most suitable synthesis model by analyzing the source time-series data's characteristics. For example, the system evaluates data volume and complexity metrics to guide model selection. In cases where sequential data requires precise information flow control, the system suggests the GRU model due to its specialized reset and update gate mechanisms that regulate temporal data processing. For datasets exhibiting complex temporal patterns and long-term dependencies, the system recommends the LSTM model, which excels at processing large-scale data with intricate temporal characteristics. The linear interpolation model is recommended for datasets demonstrating approximately linear relationships between closely spaced points. This recommendation may include information regarding its limitations with non-linear patterns and extrapolation beyond known ranges. When processing high-volume temporal datasets that require computational efficiency, the N-BEATS model is suggested, leveraging its block-based architecture for superior processing performance. The system recommends an extrapolation model for frequency variations in the source data. For datasets with interruptions or missing values due to collection gaps, sensor failures, or human errors, the system evaluates whether interpolation capabilities are needed alongside extrapolation to ensure data continuity.

During step 204, the user selects a synthesis model from the available options after receiving the system's recommendations in step 203. The user can select the suggested model or choose an alternative model that better aligns with their specific requirements. Upon model selection, the system populates default model parameters in step 205 based on the characteristics of the analyzed source data. The system presents these recommendations through its guidance interface while maintaining user flexibility to override the default parameters at step 206 based on specific requirements.

When performing time-series extrapolation, the system provides a comprehensive set of configuration controls to fine-tune the extrapolation process. Through the synthesis configuration interface, users can adjust correlation strength, signal fluctuations, and smoothing parameters using three-level settings (low, medium, high) to control the characteristics of the extrapolated data. The temporal delay settings (−2 to +2 range) allow users to adjust the temporal offset of predictions, while the random seed specification ensures reproducible results across multiple extrapolation runs. These configuration options support both forward and backward temporal extrapolation capabilities and rolling forecast functionality, with all results tracked through a project-based interface that maintains temporal stamps and status indicators for generated files.

After completing the parameter configuration and model selection steps, the system executes the data synthesis task in step 207 through an asynchronous processing architecture. This asynchronous execution enables the system to manage synthesis operations independently from other system functions, allowing users to continue interacting with the interface and performing additional tasks while synthesis is ongoing. The task execution module 130 handles the processing workflow, coordinating with the data management module 110 to store generated outputs and the notification module 140 to track task completion status. Through the project-based interface, users can monitor the progress of synthesis tasks, with the system maintaining comprehensive tracking of generated files, including temporal stamps and completion indicators.

The notification module 140 provides configurable alerts through browser or email channels to inform users when synthesis tasks are completed, with options to control notification frequency and aggregation. This asynchronous processing architecture optimizes system resource utilization by enabling parallel task execution while maintaining organized tracking and notification of task completion status through the integrated modules. The system architecture supports horizontal scaling through container orchestration, enabling dynamic resource allocation based on processing demands. Security is implemented through role-based access control and end-to-end encryption of sensitive data.

The present invention delivers a comprehensive synthetic time-series data generation solution through an integrated system architecture. Features include automated source data analysis, model selection guidance with detailed descriptions of available models, customizable parameter configuration, and asynchronous task execution. These capabilities create an adaptable framework streamlining the synthesis workflow while maintaining user control over critical processing decisions.

The system's distinctive approach to model selection guidance, driven by automated analysis of source data characteristics, represents a significant advancement over traditional methods. This computerized analysis informs the initial model recommendations and the population of default parameters, which users can modify through an intuitive configuration interface.

The system's comprehensive data processing capabilities enhance its utility across machine learning and predictive analytics applications. These capabilities include interpolation for filling data gaps, bidirectional extrapolation for extending data temporally, and sophisticated data generation that maintains characteristic patterns of the source data. Through its modular architecture and integrated processing workflow, the system provides an efficient framework for generating high-quality synthetic time series data while maintaining user control over the synthesis process.

The present invention may be implemented as a distributed computing system optimized for processing temporal data sequences. In an embodiment of the invention, the system employs a multi-tier software architecture operating across networked computing nodes, each configured with sufficient computational resources (e.g., 8-core processors, 32 GB RAM, and 1 TB storage) to handle parallel data synthesis operations.

The embodiments described herein are meant to illustrate the inventive concepts contained herein. Other embodiments and modifications may be made to the compositions and methods without departing from the spirit and scope of the invention. Therefore, the scope of the present invention should not be limited to the embodiments described herein but should be defined by the appended claims and their equivalents.

We claim:

1. A computer-implemented method for time series data synthesis, the method comprising the steps of:
receiving, at a computer, time series source data,
analyzing, at the computer, the time series source data to identify a recommended synthesis model from a plurality of synthesis models,
receiving, at the computer, an identification of a synthesis model from the plurality of synthesis models,
populating, at the computer, one or more default parameters of the identified synthesis model based on the step of analyzing the time series source data, and
generating, at the computer, synthetic time series data according to the identified synthesis model.

2. The method of claim 1 further comprises the step of receiving a modification of the one or more default parameters to form one or more modified parameters of the identified synthesis model, wherein the step of generating synthetic time series data according to the identified synthesis model utilizes the one or more modified parameters.

3. The method of claim 1, wherein the identified synthesis model is the recommended synthesis model.

4. The method of claim 1, wherein the step of generating synthetic time series data according to the identified synthesis model comprises one or more steps selected from the group consisting of: interpolating the time series source data, extrapolating the time series source data, augmenting the time series source data, and any combination thereof.

5. The method of claim 1, wherein analyzing the time series source data comprises a step selected from the group consisting of: evaluating data volume and a complexity metric, identifying a temporal pattern, analyzing a data frequency variation, detecting a missing value, assessing a multi-dimensional relationship, and a combination thereof.

6. The method of claim 1, wherein the plurality of synthesis models comprises:
a Long Short-Term Memory (LSTM) model;
a Gated Recurrent Unit (GRU) model;
a linear interpolation model; and
a Neural Basis Expansion Analysis Time Series (N-BEATS) model.

7. The method of claim 1, wherein the one or more default parameters are selected from the group consisting of: a correlation strength, a signal fluctuation, a smoothing coefficient, a temporal delay setting, a random seed value, and a combination thereof.

8. The method of claim 1, further comprising:
storing generated synthetic data with an associated timestamp; and
providing a notification indicating a completion of the step of generating synthetic time series data.

9. The method of claim 1, wherein generating synthetic time series data comprises executing synthesis tasks asynchronously while maintaining task progress tracking.

10. A method for synthesizing data according to a primary ordering variable, the method comprising the steps of:
receiving, at a computer, source data,
analyzing, at the computer, the source data to identify a primary ordering variable and a recommended synthesis model from a plurality of synthesis models for the identified primary ordering variable,
receiving, at the computer, an identification of a synthesis model from the plurality of synthesis models,
populating, at the computer, one or more default parameters of the identified synthesis model based on the step of analyzing the source data, and
generating, at the computer, synthetic data according to the identified primary ordering variable and the identified synthesis model.

11. The method of claim 10, wherein the primary ordering variable is time.

12. The method of claim 10, wherein the primary ordering variable is selected from the group consisting of: a spatial coordinate, a sequential identifier, a distance, an energy level, a hierarchical level, a process stage, age, growth stage, temperature, pressure, and any combination thereof.

13. A system for time series data synthesis, comprising:
a data management module configured to receive time series source data and validate and transform the time series source data into a standardized format optimized for synthesis operations;
a data synthesis module configured to analyze characteristics of the time series source data and recommended a synthesis model from a plurality of synthesis models based on the analyzed characteristics, populate default synthesis parameters based on the analyzed characteristics, and process the time series source data according to the recommended synthesis model; and
a task execution module configured to manage synthesis operations asynchronously, coordinate data flow between modules, track task progress and completion status, and implement task recovery for interrupted operations.

14. The system of claim 13 further comprising a notification module configured to provide an alert that data synthesis is complete.

15. The system of claim 13, wherein the plurality of synthesis models comprise a Long Short-Term Memory (LSTM) model, a Gated Recurrent Unit (GRU) model, a linear interpolation model, and a Neural Basis Expansion Analysis Time Series (N-BEATS) model.

16. The system of claim 13, wherein the data synthesis module is configured to perform interpolation to fill data gaps, extrapolation for temporal extension, or data augmentation.

17. A non-transitory computer-readable storage medium storing instructions that, when executed by a processor, cause the processor to perform operations comprising:
receiving time series source data;
analyzing the time series source data to characteristics;
automatically selecting a recommended synthesis model from a plurality of synthesis models based on the analyzed characteristics;
populating default synthesis parameters based on the analyzed characteristics; and
generating synthetic time series data according to the recommended synthesis model.

18. The non-transitory computer-readable storage medium of claim 17, wherein the plurality of synthesis models comprises a Long Short-Term Memory (LSTM) model configured to process datasets with complex temporal patterns and long-term dependencies, a Gated Recurrent Unit (GRU) model configured to process sequential data requiring precise control, a linear interpolation model configured to process datasets with approximately linear relationships, and a Neural Basis Expansion Analysis Time Series (N-BEATS) model configured to process high-volume temporal datasets.

19. The non-transitory computer-readable storage medium of claim 17, wherein generating synthetic time series data comprises a step selected from the group consisting of: performing interpolation, performing extrapolation, performing data augmentation, and tracking synthesis task completion.

20. The non-transitory computer-readable storage medium of claim 19, wherein the default synthesis parameters are selected from the group consisting of: a correlation strength, a signal fluctuation, a smoothing coefficient, a temporal delay setting, a random seed value, and a combination thereof.
